(19) United States
(12) Patent Application Publication
(10) Pub. No.: US 2006/0190438 A1
(43) Pub. Date: Aug. 24, 2006

(54) Systems, methods, and software for retrieving information using multiple query languages

(76) Inventor: James E. Brei, Milford, MI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/331,848

(22) Filed: Jan. 13, 2006

Related U.S. Application Data
(60) Provisional application No. 60/644,282, filed on Jan. 13, 2005.
(60) Provisional application No. 60/713,798, filed on Sep. 2, 2005.

(51) Int. Cl. G06F 17/30

(52) U.S. Cl. 707/3

(57) ABSTRACT

An exemplary method comprises receiving a description of query language; and automatically configuring a language converter based on the received description of the query language. The language converter, or translator, can be used to adapt a system to changing query languages.

### RELATED APPLICATION

The present application claims priority to U.S. Provisional Applications 60/644,282 and 60/713,798 which were respectively filed on Jan. 13, 2005 and Sep. 2, 2005, and which are both incorporated herein by reference.

### TECHNICAL FIELD

Various embodiments of the present invention concern information retrieval systems, particularly systems, methods, and software for processing multiple query languages.

### BACKGROUND

Some information retrieval systems provide users access to a wide variety of databases from a common search interface. The wide variety of databases frequently includes some databases that require use of a different query language than the language of a query entered at the search interface. Thus, for effective searching of these databases, these systems include query translators that translate input queries into queries that are compatible with other query languages.

One problem the present inventor has recognized in such systems concerns their inability to adapt to query language changes. Query translators are typically designed and built to translate queries from one specific language to another specific language. Thus, if the language of the input query is altered or redefined, the translator will not produce a useful translation. The translator can be redesigned and coded to accommodate changes, but redesign and recoding are costly in terms of system downtime and programming resources. Moreover, even if the query languages are stable, the system itself may be expanded to include new databases that require designing and building new translators.

Accordingly, there is a need for alternatives to the conventional approach of translating queries for use with multiple databases.

### SUMMARY

To address this and/or other needs, the present inventors have devised one or more systems, methods, and software for translating queries in information retrieval systems. One exemplary method entails receiving a description of a query language, and automatically configuring a language translator or converter based on the received description of the query language. The method further comprises normalizing a user query using the automatically configured language converter and then generating multiple translations of the normalized query for use with multiple corresponding contents sets or database. Results from each database are then aggregated to produce comprehensive search results.

### BRIEF DESCRIPTION OF THE DRAWINGS

FIG. 1 is a block diagram of an exemplary information retrieval system 100 which corresponds to one or more embodiments of the invention.

FIG. 2 is a flow chart of an exemplary method which corresponds to one or more embodiments of the invention.

FIG. 3 is a flow chart of an exemplary method which corresponds to one or more embodiments of the invention.

### DETAILED DESCRIPTION OF EXEMPLARY EMBODIMENT(S)

This description, which incorporates the Figures and the claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

### Exemplary Information Retrieval System

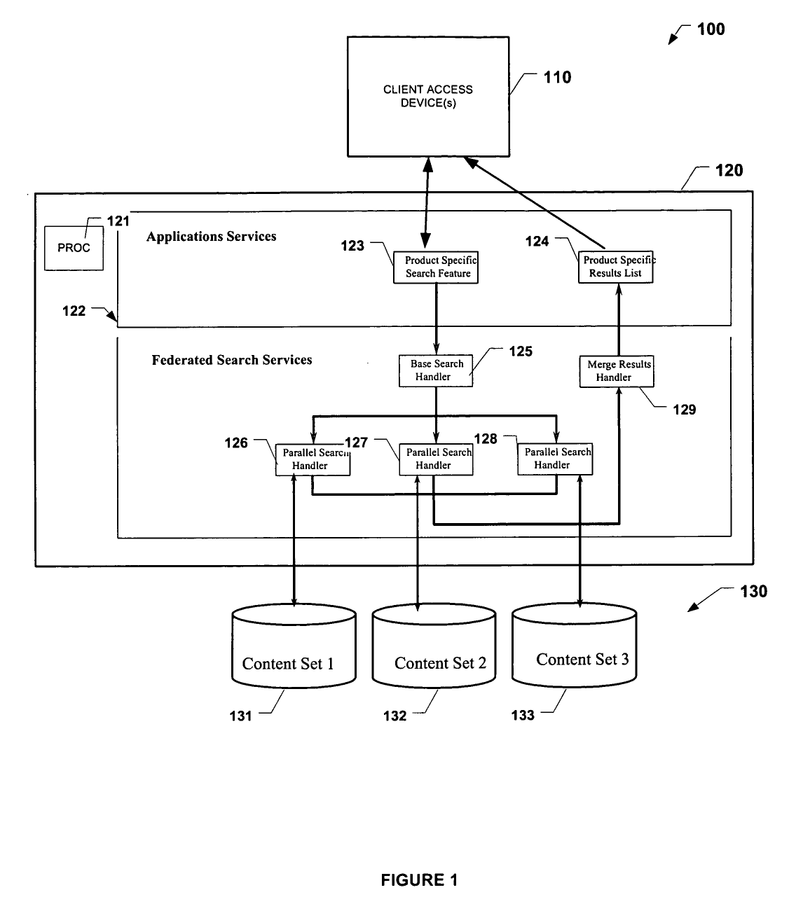

FIG. 1 shows an exemplary information retrieval system 100 incorporating teachings of the present invention. System 100 includes a client access device 110, a server 120, and content sets 130.

Client access device 110, which is generally representative of one or more access devices, includes hardware and software for communicating over a network with server 120.

Server 120 includes, among other things, a processor module 121 and a memory module 122. Memory module 122 includes software (machine-readable or executable instructions) for providing a product-specific search feature 123, a product-specific result feature 124, a base search handler 125, parallel search handlers 126, 127, and 128, and a merge results handler 129.

Product-specific search feature 123 and result feature 124 are part of an applications services layer that may interact with client access device 110. Search feature 123 receives a query from an access device 110. Result feature 124 may take the form of results lists.

Base search handler 125 generally has the function of normalizing a query and defining search paths to specific parallel search handlers based on a product specific search or query. In the exemplary embodiment, normalization generally entails capturing the essential structure of an incoming query in a neutral tree form, such as an abstract syntax tree (AST). For example, normalization of a Gale CQL Query

“cat” prox/=/2//ordered “hat” (cat within two words of hat) yields the following XML structure:

<query>
<positionalexpr type=“unidirectional” value=“2”>

<queryterm type=“text” value=“cat”/>
<queryterm type=“text” value=“hat”/>

</positionalexpr>

</query>

In one embodiment, one of the parallel search handler, converts or translates this normalized query into “cat W2 hat”, and another search handler translates it to “cat/2 hat.” In another embodiment, base search handler 122 receives the “cat within 2 of Hat” query in a form compliant with Z39.50 RPN Query: cat hat within/2 and normalizes this to:

<query>
<positionalexpr type=“unidirectional” value=“2”>

<queryterm type=“text” value=“cat”/>
<queryterm type=“text” value=“hat”/>

</positionalexpr>

</query>

One of the search handlers translates or denormalizes this neutral tree form to QF (CCL) query: “cat W2 hat” In response to receiving a Gale QF Command scan (JN=management), the base search handle normalizes the command to

<query>

<command type=“scan”>

<queryterm field=“JN” value=“management”/>

</command>

</query>

Which can be converted to QF: scan (JN, “management”)

Parallel search handlers 126, 127, and 128 (also referred to as agents or target agents) have the functions of managing state and security issues with content sets 130. Also, in some embodiments, the search handlers handle separate types of searches, and in other embodiments they handle the same type of search. In some embodiments, the parallel search handlers normalize found content from content sets 130 prior to routing it to merge results handler 120.

Merge results handler 129 has the function of receiving partial results sets from one or more of the parallel search handlers and merging these results into a complete result set, such as a result list. The completed result set is then routed back to client acess device 110

Content sets 130 include content set 131, 132, and 133, which are respectively coupled or couplable to parallel search handlers 126, 127, and 128. Content sets 130 can take any variety of forms; however, in the exemplary embodiment of FIG. 1 each uses a different query language than the other. In some embodiments, one or more of the content sets mirror the content of another content set for reasons of redundancy or responsiveness.

### Exemplary Method of Operating an Information Retrieval System

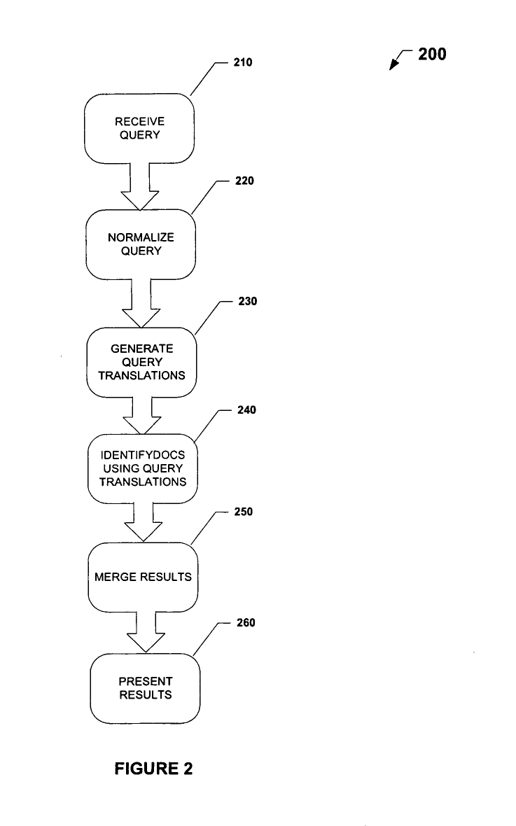

FIG. 2 shows a flow chart 200 of an exemplary method of operating an information retrieval system, such as system 100 in FIG. 1. Flow chart 200 includes blocks 210-260, which are arranged and described serially. However, other embodiments execute two or more blocks in parallel using multiple processors or processor-like devices or a single processor organized as two or more virtual machines or sub processors. Other embodiments also alter the process sequence or provide different functional partitions or blocks to achieve analogous results. Moreover, still other embodiments implement the blocks as two or more interconnected hardware modules with related control and data signals communicated between and through the modules. Thus, the exemplary process flow applies to software, hardware, and firmware implementations.

At block 210, the exemplary method begins with receiving a query. In the exemplary embodiment, this entails client access device 110 communicating a query (in the form of text string) over a network, such as the Internet, to server 120, specifically product specific search feature 123. Execution then advances to block 220.

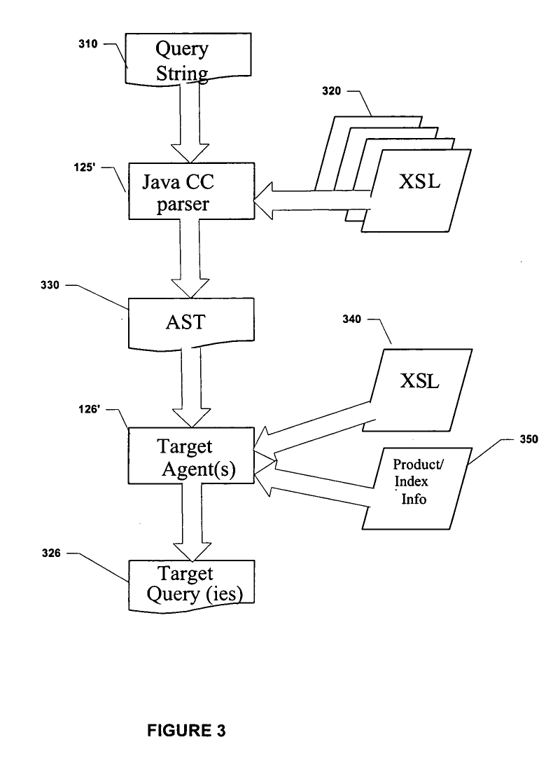

Block 220 entails normalizing the query. In the exemplary embodiment, this normalization is performed by base search handler 125. In some embodiments, as shown for example, in FIG. 3, base search handler 125 assumes the form of a JAVA parser 125′, which is configurable based on a selected extensible style language (XSL) sheet or input which describes the form of the query. Thus, in this sense, base search handler 125 can be readily adapted or configured to normalize virtually any query structure into the desired AST form. Exemplary execution continues at block 230.

Block 230 entails translating the normalized query into multiple query languages. In the exemplary embodiment, this entails base search handler 125 in FIG. 1 (or parser 125′ in FIG. 3) communicating the normalized query (AST) 330 to each of one or more, generally two or more of parallel search handlers 126-127 (or target agents 126′) In turn, the parallel search handlers translate the normalized query to the specific query language of their corresponding target content. In some embodiments, the parallel search handlers (or target agents) generate translations (or target queries) based on XLS inputs and/or product or index information. However, in other embodiments, one or more of the parallel searching handlers is fixed in relation to the others.

Block 240 entails identifying content or documents based on the translated queries from block 230. In the exemplary embodiment, the queries are processed by search engines native to one or more of content sets 130 to produce respective set of partial search results for each of the content sets.

Next, block 250 entails merging the results into a result list. To this end, the exemplary embodiment causes each parallel search handlers that participated in the translation and to communicate its respective results to merge results handler 129. Execution then continues at block 260.

Block 260 entails presenting the search results to the user. In the exemplary embodiment, the results are communicated to client access device 110.

### CONCLUSION

The embodiments described above and in the claims are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

1. A method comprising:
receiving a description of query language; and
automatically configuring a language converter based on the received description of the query language.

2. The method of claim 1, further comprising:
receiving a user query over an Internet connection from a client access device;
processing the user query using the automatically configured language converter to define a normalized query;
using a first translated version of the normalized query to identify documents in a first database;
using a second translated version of the normalized query to identify documents in a second database; and
returning search results identifying documents from the first and second databases to the client access device.

3. The method of claim 1, wherein automatically configuring the language converter comprises receiving at one XML style sheet and configuring a parser based on the XML style sheet.

4. The method of claim 1, wherein the normalized query has an abstract syntax tree.

5. A system comprising:
means for receiving a description of query language; and
means for automatically configuring a language converter based on the received description of the language converter.

6. The system of claim 5, further comprising:
means for receiving a user query over an Internet connection from a client access device;
means for processing the user query using the automatically configured language converter to define a normalized query;
means, responsive to a first translated version of the normalized query, to identify documents in a first database;
means, responsive to a second translated version of the normalized query, to identify documents in a second database; and
means for returning search results identifying documents from the first and second databases to the client access device.

7. An information-retrieval system comprising:
means, responsive to a first query language description, for normalizing a query; and
means, responsive to second query language description, for translating the normalized query into a first target query suitable for a first predetermined database.

8. The system of claim 7 further comprising client access device for providing the query.

9. The system of claim 7, further comprising means, responsive to third query language description, for translating the normalized query into a second target query suitable for a second predetermined database.

10. The system of claim 9, further comprising means for merging first search results from the first database based on the first query with second search results from the second database based on the second query.

11. An information-retrieval system comprising:
a base search handler, responsive to a first query language description, for normalizing a query; and
a first parallel search handler, responsive to second query language description, for translating the normalized query into a first target query suitable for a first predetermined database.

12. The system of claim 11, wherein the base search handler comprises means for normalizing the query.

13. The system of claim 11, wherein the first parallel search handler comprises means for translating the normalized query.

14. The system of claim 11, further comprising a second parallel search handler, responsive to a third query language description, for translating the normalized query into a second target query suitable for a second predetermined database.
